(19) United States
(12) Patent Application Publication
(10) Pub. No.: US 2012/0047021 A1
(43) Pub. Date: Feb. 23, 2012

(54) System and method for marketing business leads with white papers

(75) Inventors: Michael J. Borchetta, Stamford, CT (US); Michael D. Frank, New Canaan, CT (US)

(73) Assignee: M2 Media Group

(21) Appl. No.: 13/134,007

(22) Filed: May 25, 2011

Related U.S. Application Data
(60) Provisional application No. 61/374,737, filed on Aug. 18, 2010.

(51) Int. Cl. G06Q 30/00

(52) U.S. Cl. 705/14.66

(57) ABSTRACT

A system for promoting business leads for authors of literature to a consumer by a document service provider (DSP) that stores and manages the literature via the Internet, where the consumer has a computer device for accessing product information via the Internet at a website of a product service provider (PSP). The system includes at least one computer device operable to receive, via the Internet, profile information of the consumer from the PSP while the consumer is reviewing product information from the website of the PSP; identify, at the DSP, a corresponding document associated with a product being viewed at the website of the PSP by the consumer; present, on the consumer computer device, a lead promotional web page that includes an offer by the DSP to the consumer for the corresponding document; and deliver the corresponding document to the consumer in response to receiving an acceptance of the offer.

### CROSS REFERENCE TO RELATED APPLICATION

This patent application claims the benefit of U.S. Provisional Application, Ser. No. 61/374,737, filed Aug. 18, 2010, the contents of which are incorporated by reference herein in its entirety.

### FIELD OF THE INVENTION

The present invention relates generally to distributing literature to targeted consumers via the Internet, and more specifically to a system and method for distributing personalized white papers and other technical journals to targeted consumers that access third party websites for goods and/or services via the Internet.

### BACKGROUND OF THE INVENTION

White papers are used to educate readers and help them make informed decisions in various commercial and governmental fields. There are different types of white papers which address different issues. One type of white paper is directed to business-benefits, which present a business case for a certain technology or methodology. Another type of white paper is a technical white paper, which describes how a certain technology works. A hybrid white paper combines high-level business benefits with technical details in a single document. Yet another type of white paper is directed to policies, such as governmental or commercial policies, which present a case for a certain political solution to a societal or economic challenge. For example, policy makers frequently request white papers from universities or academic personnel to inform policy developments with expert opinions or relevant research.

The term “while paper” has also come to refer to documents used by businesses and so-called “think tanks” as marketing or sales tools. These types of white papers typically set forth discussions or arguments claiming that the benefits of a particular technology, product or policy are superior for solving a specific problem.

Commercial white papers are almost always marketing communications documents designed to promote a specific company's or group's solutions or products. As a marketing tool, these papers highlight information favorable to the company authorizing or sponsoring the paper. Such white papers are often used to generate sales leads, establish thought leadership, present a business case, or to educate consumers or voters.

Published white papers are available to interested persons for downloading or viewing on the Internet, usually for free or for a small fee. Alternatively, a publisher of a white paper may provide an interested person with a white paper via the Internet as a promotional marketing tool. However, the distribution of a white paper via the Internet is restricted to consumers accessing the publisher's web site. There is currently no broad distribution system for disseminating targeted published white papers to consumers based on their consumer profile information and selection of goods and/or services that they are accessing or using while browsing the Internet. Moreover, publishers of white papers often find it difficult to expand their “customer base”, i.e., consumers who may be interested in reading a white paper on a particular subject matter via the Internet. Therefore, there is a need to provide authors and sponsors of white papers with a system and method to enable expansion of the distribution of their white papers and other published documents via the Internet.

### SUMMARY OF THE INVENTION

In one aspect of the present invention, a novel method is provided for distributing white papers to consumers accessing third party websites as business leads for various products and/or services. The present invention enables authors of white papers to expand distribution of their published white papers by partnering with a white paper distribution center or document service provider (DSP). The DSP establishes business relationships with companies and other entities serving as product service providers (PSP) that offer for sale or otherwise make available products (i.e., goods and/or services) to consumers via the Internet. As used herein, the term “products” includes goods and/or services.

When a consumer uses a communications device, such as a computer, smart phone, or other consumer communication device to access the Internet to view or purchase products from a PSP which has partnered or otherwise established business relations with a DSP, the consumer is presented with a web page that offers an opportunity to receive a targeted white paper associated with a product of the PSP. If the consumer accepts the promotional offer of the white paper, it is emailed or otherwise made available (e.g., by downloading) to the consumer.

In one embodiment, the present invention includes a method of promoting business leads for authors of literature to a consumer by a document service provider that stores and manages (e.g., identifies, retrieves and transmits) the literature via the Internet, the consumer having a computer device for accessing product information via the Internet at a website maintained by a product service provider, the method comprising the steps of: receiving, via the Internet, profile information of the consumer from the product service provider while the consumer is browsing product information or utilizing services from the website of the product service provider; identifying, at the document service provider, at least one corresponding document associated with a product being viewed at the website of the product service provider by the consumer; presenting, on the consumer computer device, a lead promotional web page graphical user interface (GUI) that includes an offer by the document service provider to the consumer for the corresponding document; and delivering the corresponding document to the consumer in response to receiving an acceptance of the offer.

In one aspect, the receiving step further comprises storing the consumer profile information in a database. In another aspect, the literature includes a plurality of white papers associated with various commercial and governmental entities.

In yet another aspect, the identifying step includes the step of filtering documents based on the product selected by the customer on the website of the PSP and the customer profile information. The filtering step can include identifying at least one category of interest (i.e., consumer interest) including technology, arts, social sciences, health, geography, politics, history, business, religion and social services. Further, the filtering step can include identifying document lead criteria including at least one of quotas and document payment rates.

In one aspect, the presenting step further includes generating the lead promotional web page with prompts for completing a plurality of fields associated with additional customer profile information. Additionally, the presenting step can include generating the lead promotional web page with prompts for accepting and declining the offer for the corresponding document.

In yet another aspect the presenting step comprises the step of automatically displaying the promotional web page GUI on the computer device of the consumer from a website hosted by the document service provider in response to URL redirection from the product service provider. In one embodiment the presenting step further includes providing URL redirection at the document service provider to enable the consumer computer device to access a confirmation web page from the website hosted by the product service provider. Alternatively, the presenting step includes the steps of receiving a request over the internet from the product service provider for the promotional web page GUI; and sending data for generating the promotional web page GUI over the internet from the document service provider to the product service provider, wherein the promotional web page GUI is hosted by the product service provider for display on the computer device of the consumer.

In another aspect of the present invention, the method includes aggregating a number of occurrences that the document was delivered to consumers; and delivering an invoice to the author for payment based on the aggregated number. Further, the delivery step can include sending the document to the customer via email and/or providing a link on a webpage for downloading the document.

In another embodiment of the present invention, a system for promoting business leads for authors of literature to a consumer by a document service provider that stores and manages the literature via the Internet is provided, where the consumer has access to a consumer computer device for accessing product information via the Internet at a website of a product service provider. The system includes at least one computer device having memory for storing a promotional web page module and a processor for executing instructions therefrom, at least one computer device being operable to receive, via the Internet, profile information associated with the consumer from the product service provider while the consumer is reviewing product information from the website of the product service provider; identify, at the document service provider, at least one corresponding document associated with a product being viewed at the website of the product service provider by the consumer; present, on the consumer computer device, a lead promotional web page graphical user interface (GUI) that includes an offer by the document service provider to the consumer for the corresponding document; and deliver the corresponding document to the consumer in response to receiving an acceptance of the offer.

In one aspect, at least one computer device is further operable to store the literature. In another aspect, the literature includes a plurality of white papers. Further, at least one computer device is operable to filter the plurality of white papers for delivery to the consumer based on at least one category of interest from the fields of technology, arts, demographics, health, geography, politics, history, business, religion, social services, and consumer profile information. In yet another aspect, at least one computer device is further operable to store the customer profile information. In another aspect, at least one computer device is operable to store the profile information associated with the PSP.

In still another aspect, the promotional web page module includes programmed instructions to generate the lead promotional web page GUI, where the lead promotional web page GUI includes a description (e.g., title, abstract, synopsis and/or the like) of a document selected from the literature specifically for delivery to the customer and means for accepting or declining the offer. The at least one computer device is operable to receive over the internet a request to accept or decline the offer for the document from the consumer computer device. Alternatively, the lead promotional web page GUI is generated in response to the consumer computer device being redirected from the website of the product service provider to a website hosted by the document service provider.

In another embodiment of the present invention, a system for promoting business leads for authors of literature to a consumer by a document service provider that stores and manages the literature via the Internet is provided, where the consumer has a computer device for accessing product information via the Internet at a website of a product service provider. The system includes at least one first computer device having memory for storing a promotional web page module and a processor for executing instruction therefrom, said first computer device operable to: receive, via the Internet, profile information of the consumer from the product service provider while the consumer is reviewing product information from the website of the product service provider; identify, at the document service provider, at least one corresponding document associated with a product being viewed at the website of the product service provider by the consumer; present, on the consumer computer device, a lead promotional web page graphical user interface (GUI) that includes an offer by the document service provider to the consumer for the corresponding document; and deliver the corresponding document to the consumer in response to receiving an acceptance of the offer; and at least one second computer device having memory for storing a product web page module and a processor for executing instruction therefrom, said second computer device operable to present, on the consumer computer device, one or more web pages including descriptions of good and/or services available for selection by the consumer via the Internet; and at least one database including stored literature and communicably coupled to the document service provider.

In one aspect, the promotional web page module includes programmed instructions to generate the lead promotional web page GUI, the lead promotional web page GUI including a description of a document selected from the literature for delivery to the customer, and means for accepting or declining the offer.

In yet another aspect, the at least one second computer device is operable to redirect the consumer computer device to the at least on first computer device to view the lead promotional web page GUI in response to the consumer computer device sending a request for selected goods and/or services. Alternatively, the at least one second computer device is operable to send a request to the at least on first computer device to receive data for generating the lead promotional web page GUI in response to the consumer computer device sending a request for selected goods and/or services, and the at least one first computer device sends the data to the at least one second computer device which generates the lead promotional web page GUI for display on the consumer computer device.

### BRIEF DESCRIPTION OF THE DRAWINGS

FIG. 1 is a block diagram of a white paper promotional lead distribution system in accordance with the present invention;

FIGS. 2A-2D collectively depict a flow diagram of a method for displaying a promotional web page associated with white papers to a consumer currently viewing a web page for a product associated with a produce service provider;

FIGS. 3A-3C collectively depict a flow diagram of another method for displaying a promotional web page associated with white papers to a consumer currently viewing a web page for a product associated with a produce service provider;

FIG. 4 is block diagram of a computer device suitable for use by a product service provider in the system FIG. 1;

FIG. 5 is block diagram of a computer device suitable for use by a business-to-business service provider in the system FIG. 1; and

FIGS. 6A-6E collectively depict a series of web pages displayed by the product service provider in accordance with the methods of FIGS. 2A-2D and 3A-3C.

To facilitate understanding of the invention, the same reference numerals have been used when appropriate, to designate the same or similar elements that are common to the figures.

### DETAILED DESCRIPTION OF THE PREFERRED EMBODIMENTS

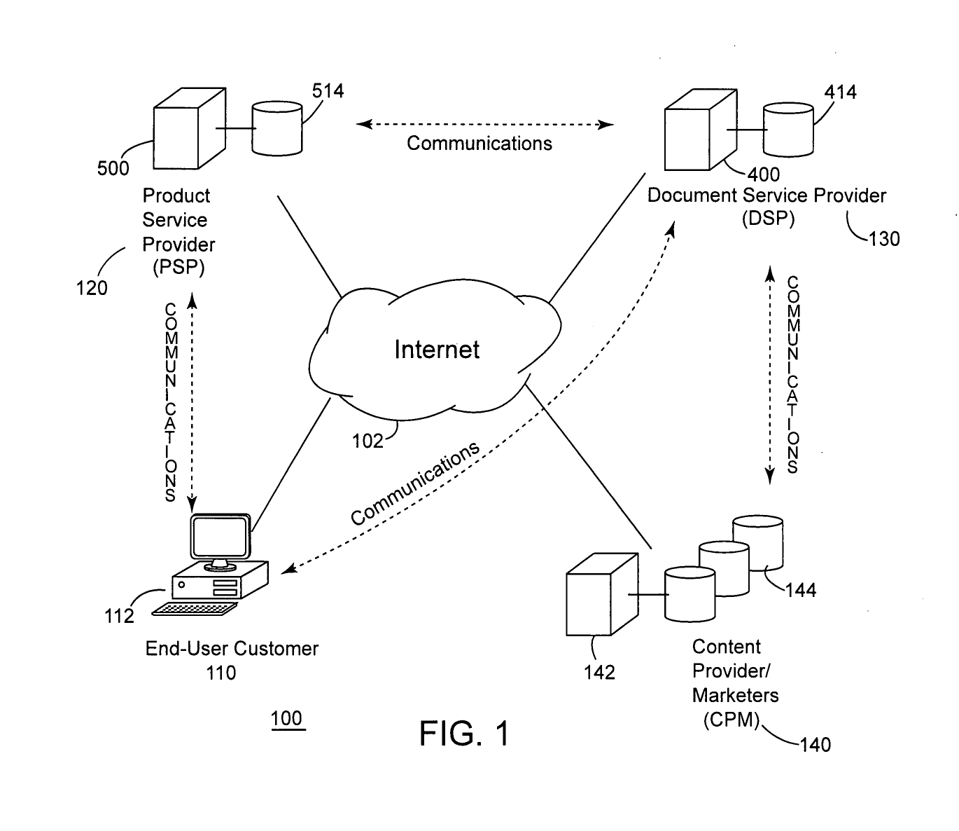

As shown and discussed with respect to FIGS. 1-5, the present invention provides a system and method for marketing business leads for authors of white papers or other journals to end-user customers (i.e., consumers) which view product or service information on a web page hosted by a third party product service provider. Unless indicated otherwise, the end-user designations “customer” and “consumer” are used interchangeably and have the same conventional definition of a current or potential buyer or user of a product of an individual or organization, such as a supplier, seller, or vendor (i.e., hereinafter “service provider”). Generally, the system and methods described herein provide an “interstitial” or lead promotion web page that is viewable by a consumer on an end-user computer device having connectivity to the Internet and a web browser, or other well-known software program(s) (e.g., SMS) or protocol(s) (e.g., FTP) to access and transfer information/data via the Internet. As described below in greater detail, the interstitial web page includes an offer for a white paper or other document (i.e., literature) that is pre-selected (i.e., “personalized”) for the consumer and which corresponds to a product being searched by the consumer at a third party website that displays or otherwise offers products (i.e., goods and/or services) for review and/or sale. In this manner, the offer for the white paper serves as a lead promotion for the author(s) of the white paper or other promoted literature.

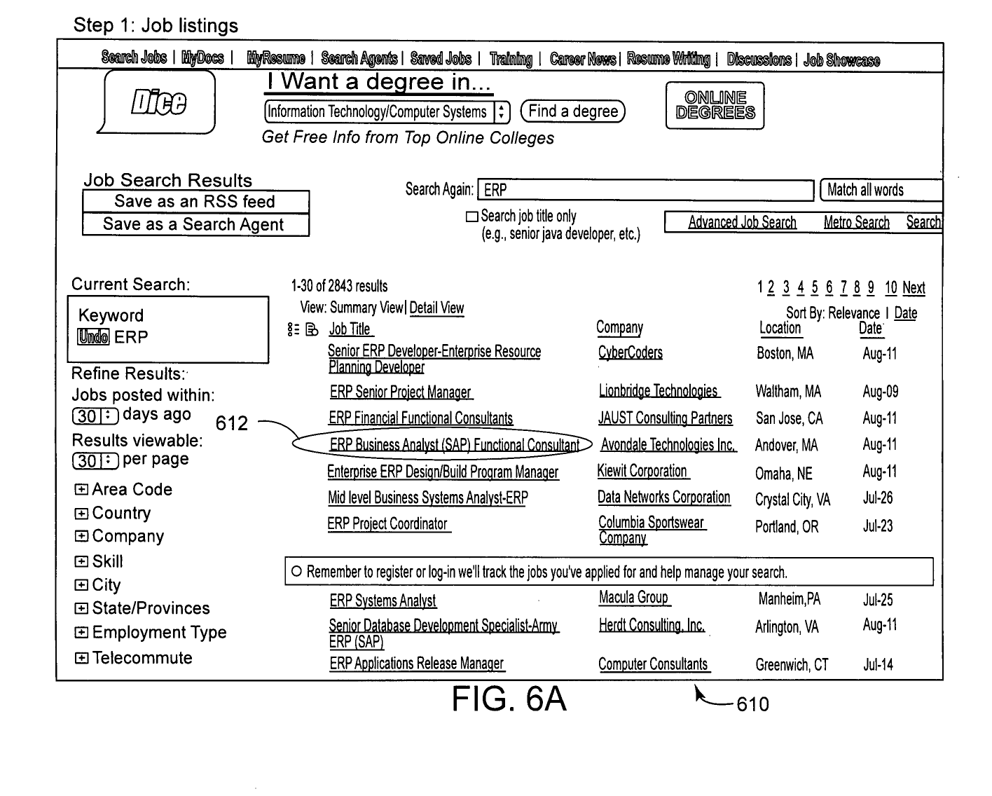

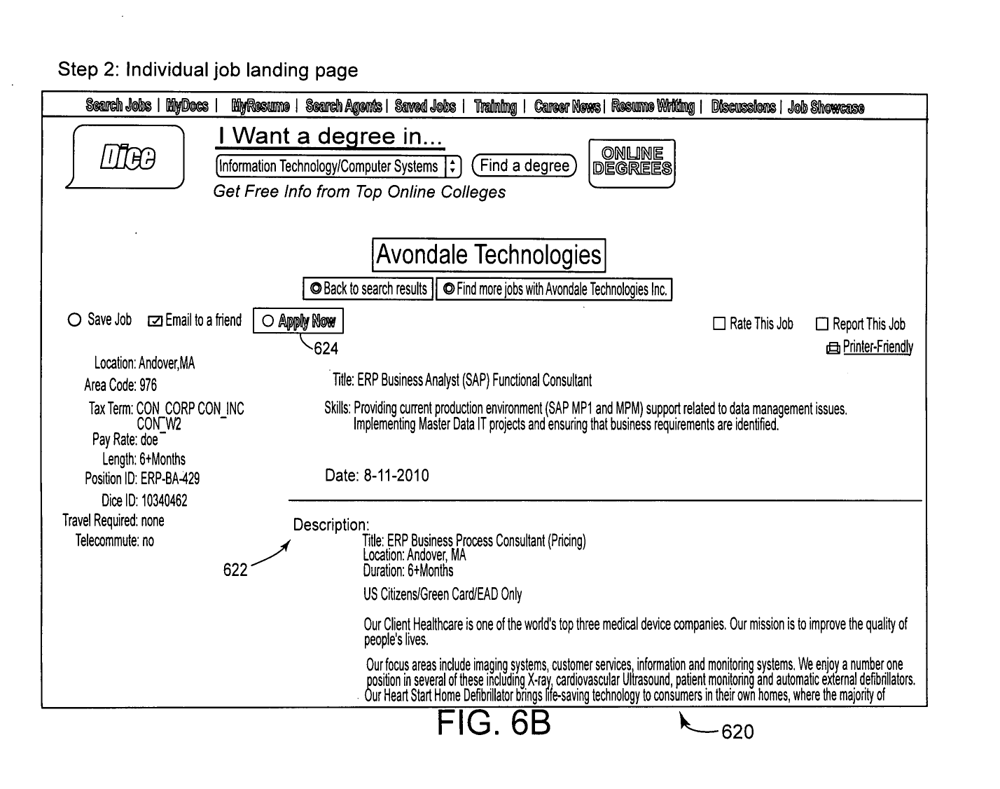

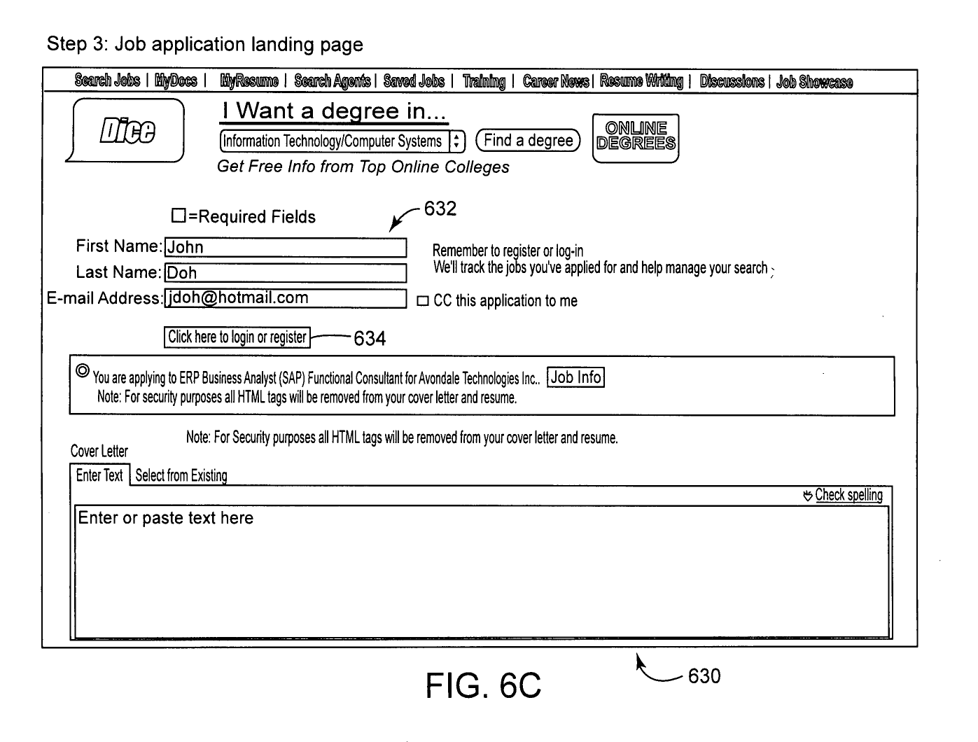

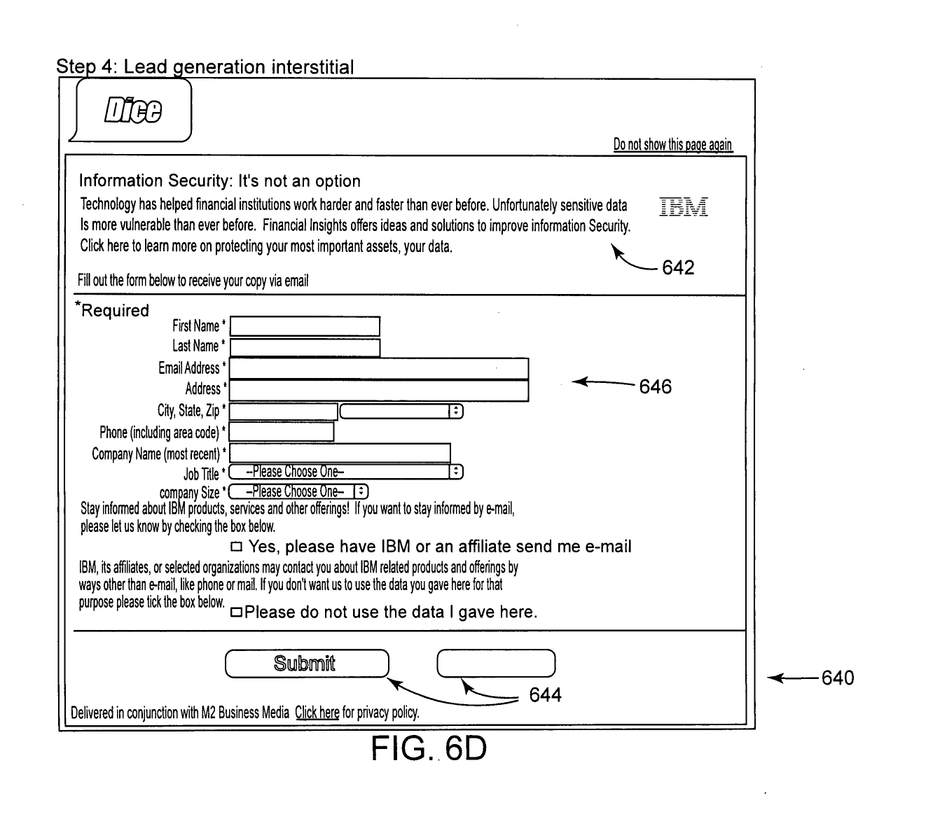

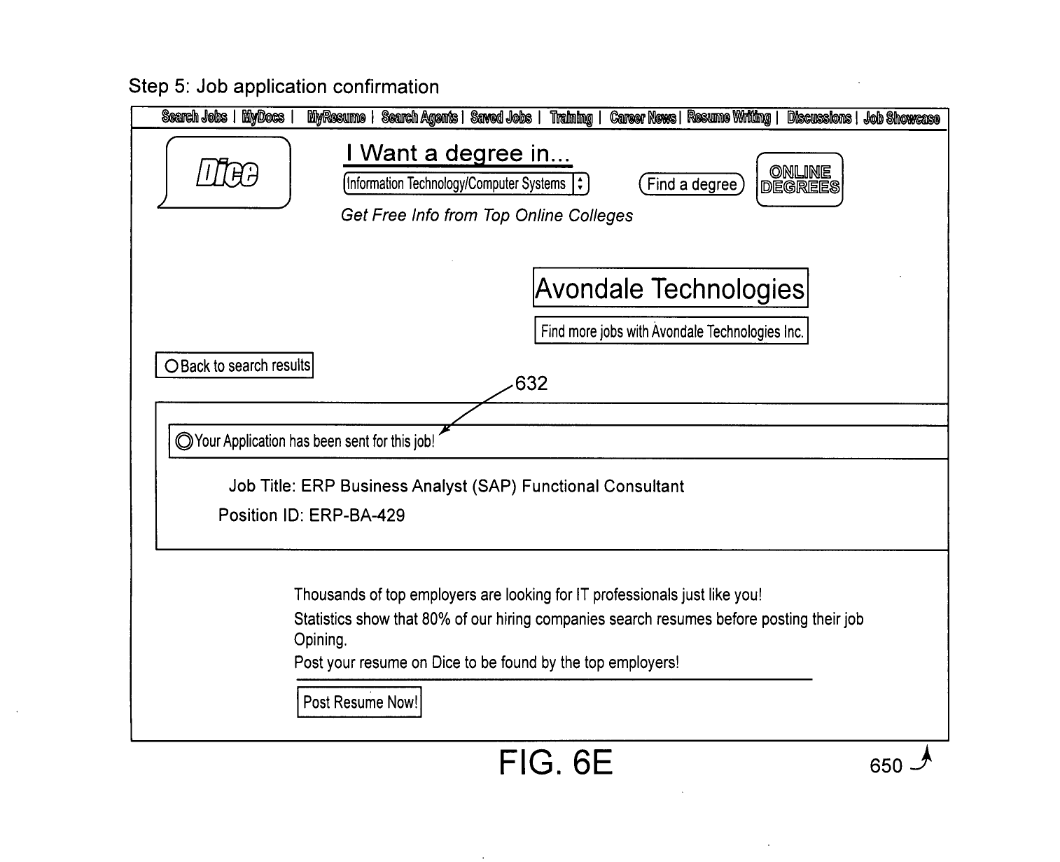

More specifically, and in accordance with one aspect of the present invention, a consumer uses an Internet browser on a computer device to access the Internet and go to a website of a desired vendor or other entity (i.e., product service provider) offering a product for review or sale to the public. The consumer browses the website and selects a particular product of interest, as well as provides consumer profile information, such as name, address, occupation and the like to the product service provider. The consumer profile information is sent via the Internet to a second service provider that promotes business leads by sending selected literature to the consumer based on at least the consumer profile information and the product selected by the consumer on the product service provider's website. The second service provider can be partnered or have some other business arrangement affiliated with the product service provider to ensure privacy of the consumer profile information. The second service provider (hereinafter “document service provider”) generates a lead promotional (i.e., interstitial) web page that includes at least an offer for a free document, such as a white paper or other journal, along with a brief description thereof and a button or other interactive medium for the consumer to accept or decline the promotional offer on the website. An example of a lead promotional web page generated by the DSP and providing an offer for a white paper is illustratively shown in FIG. 6D.

In one embodiment, the PSP redirects the consumer to the promotional web page being hosted at the domain of the DSP via URL (uniform resource locator) redirection. Alternatively, the data for the promotional web page is sent over the Internet from the DSP to the product service provider's computer device (e.g. web server), which generates and temporarily hosts the promotional web page for presentation on the consumers computer device in the form of a graphical user interface.

In either embodiment, the consumer can then interact with the web browser (e.g., click on the button or other user interface) to accept or decline the offer to receive the free document (e.g., white paper). If the consumer declines the offer, the web page from the DSP automatically closes, and the consumer returns to viewing the previous web page from the product (i.e., first) service provider. Alternatively, if the consumer accepts the offer, the web page from the DSP automatically closes and the PSP generates a new confirmation web page which is presented on the browser of the consumer computer device. The free document is then delivered by the DSP to the consumer as a PDF file (or other file format) by email or a link is provided on the consumer' web browser so the free document can be downloaded directly from the product service provider's website to the consumer's computer device. The consumer can then view the document or save it, for example, as a PDF file for future access.

The present invention enables a consumer to obtain a free document, such as a white paper, which is associated with or otherwise corresponds to the subject matter of the product that the consumer was interested in reviewing or purchasing at the product service provider's website. In this manner, the white paper can be more broadly distributed as a promotional instrument for obtaining future business leads for services. For example, if the author of the document also provides consulting services, the published white paper or other document can be useful for promoting the consultant's name, business skills and qualifications to the consumer. Additionally, the PSP and the DSP can share in revenues received from the author for each author's document sent to a consumer. Moreover, the white paper can provide additional marketing and promotional value for products of the PSP.

The present invention is shown and described by illustratively using an employment service provider that operates (i.e., offers its products and information) via the Internet, and which can be accessed by consumers using any computer device having a web browser. The employment service provider's product includes displaying job listings, job descriptions, among other products and features via the Internet. Accordingly, this job listing “product” is for illustrative purposes only and a person of ordinary skill in the art will appreciate that the “product” can be any goods or services that are offered or otherwise available by accessing the website of a product service provider via the Internet.

Referring to FIG. 1, a block diagram of an electronic document distribution system 100 for promoting business leads for authors of literature to consumers via the Internet in accordance with the present invention is illustratively shown. As illustrated, the principal business entities involved in the document distribution system 100 includes a product service provider (PSP) 120, a document service provider (DSP) 130, content providers/marketers (CPM) 140, and a consumer 110 who purchases a product from the PSP 120 and optionally receives a free document from the DSP 130. The PSP 120, document service provider 130, content providers 140 and consumers 110 are electronically coupled to the Internet 102 to enable communications and transfer of information therebetween in a well-known manner.

The PSP 120 can be any entity that offers for sale, promotes, distributes and/or otherwise makes available goods and/or services (i.e., “products”) to consumers 110 via the Internet 102. For purposes of understanding the present invention, the PSP 120 is illustratively shown and described with respect to an internet employment company (e.g., DICE.COM™), which currently provides employment services directed to technological and engineering positions. However, those of ordinary skill in the art will appreciate that the PSP 120 can be any entity associated with any public or private interest, such as business, education, politics, or religion, among other interests that offer products for purchase or acceptance by consumers. For example, the PSP 120 can be a semiconductor business offering integrated chips (ICs) for sale, or a museum offering free programs related to artworks and the like, or an accountant offering tax preparation services, or an online music store offering downloadable music for sale, among the many other commercial, governmental or, charitable entities that offer products (i.e., goods and/or services) to consumers via the Internet 102.

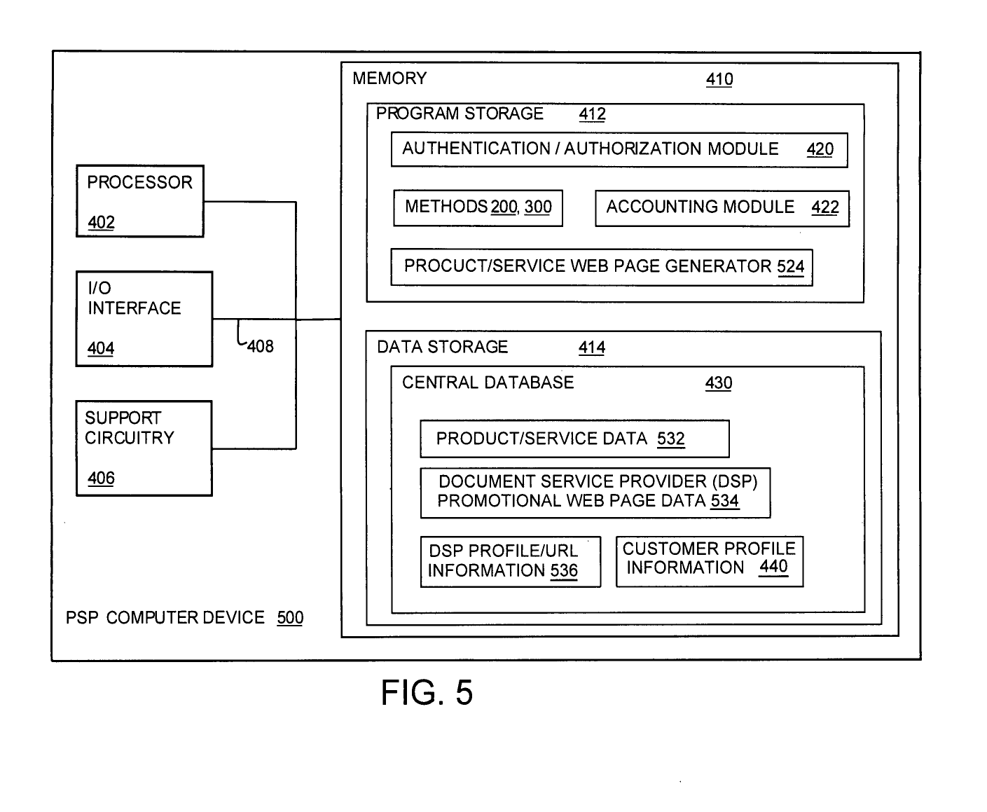

The PSP 120 includes at least one computer device 500 with memory devices 514 which are operable to store product information, generate and host web pages on the Internet 102, transfer/exchange communications and data via the Internet 102, provide security, and the like. Further details regarding the computer device 500 and memory device 514 are described below with respect to FIG. 5.

The content providers/marketers 140 include authors and/or their assignees of literary works, such as white papers, trade journals, and the like. For example, the content providers 140 can be individual authors that publish white papers and who also perform consulting services in a particular technological field, such as fiber optics, internet security, among other technological fields. Alternatively, the content providers 140 can be corporate entities that employ engineer sales representatives or other personal to publish white papers or journals related to their field of employment and products that the corporation produces. By way of example, the CPM 140 can be a partnership of surgeons that individually or collectively publish a white paper relating to new techniques for performing surgery or recovery thereafter. Common to all of the CPMs 140 is that they have published a document or set of documents, such as a white paper, journal or other literature related to their field of interest and/or occupation. Each CPM 140 stores their published documents electronically in a memory device 144 that is accessible (i.e., readable/writable) by a computer device 142. As discussed below in further detail, these documents can be used as promotional tools to entice further business with individuals or other businesses using the Internet to search for related products.

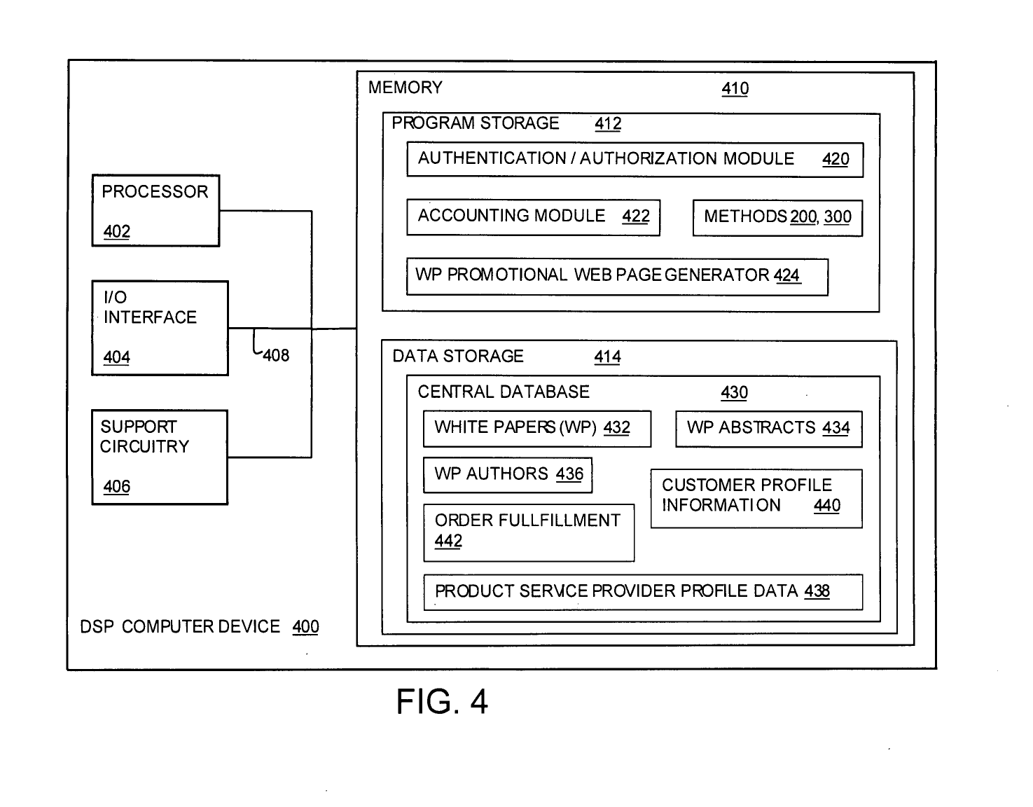

The document service provider (DSP) 130 includes at least one computer device 400 having memory 414 for storing a repository of literature, such as the white papers and journals published by the CPMs 140. Further details regarding the computer device 400 and memory 414 are described below with respect to FIG. 4.

In one aspect of the present invention, the DSP 130 establishes business relationships with the CPMs 140 and the PSP 120. The CPMs 140 electronically send their white papers or other published literature to the DSP 130 and these documents are stored in the repository of the DSP 130. The DSP 130 collects revenues from each content provider upon distribution of the document to an end-user customer from its repository 414. Various payment schedules can be negotiated, such as payment by the CPM 140 for each distributed document, a flat fee, or any other fee schedule or consideration deemed acceptable to the parties.

The DSP 130 also has a business relationship with the PSPs 120. This business relationship enables the DSP 130 to present a webpage to an end-user customer while viewing the website of the PSP 120, e.g., via URL redirection. Similarly, various payment schedules can be negotiated, such as revenue sharing for each distributed document, a flat fee, or any other fee schedule or consideration deemed acceptable to both parties.

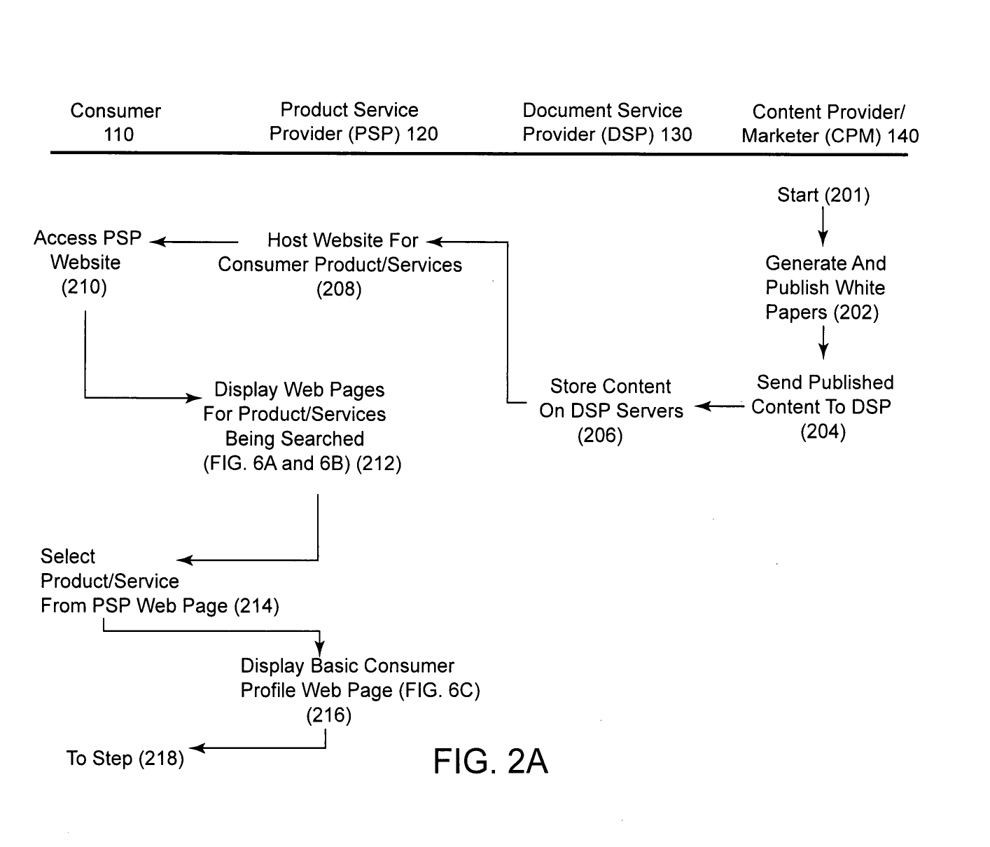

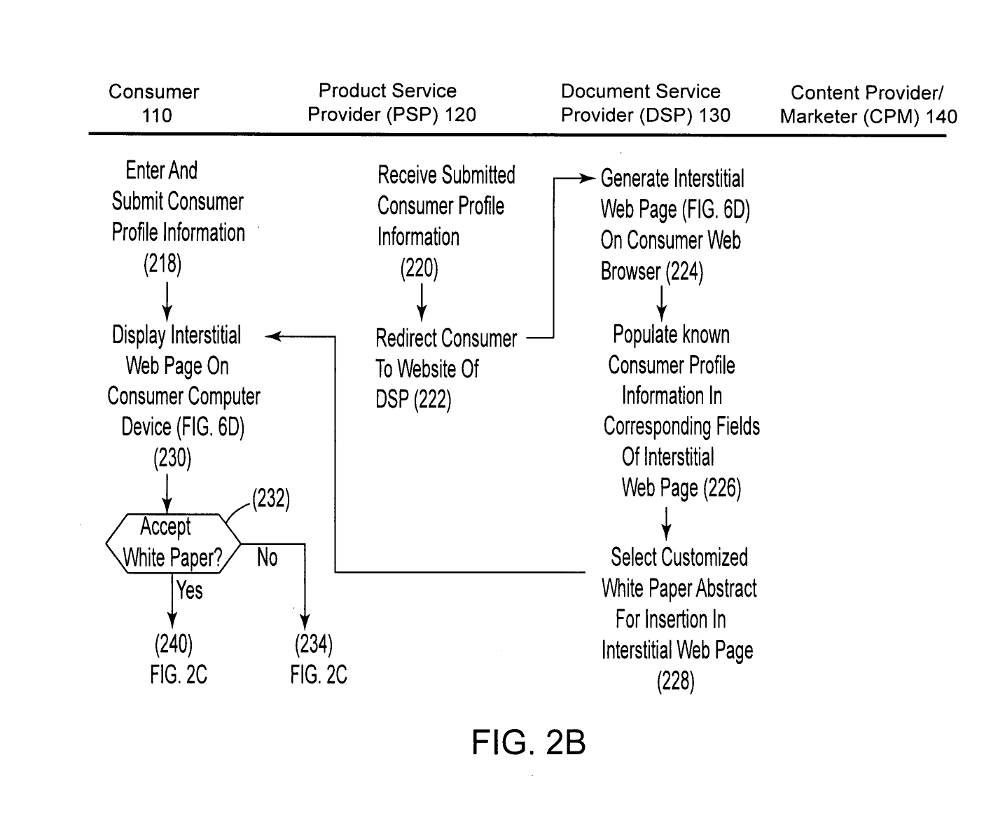

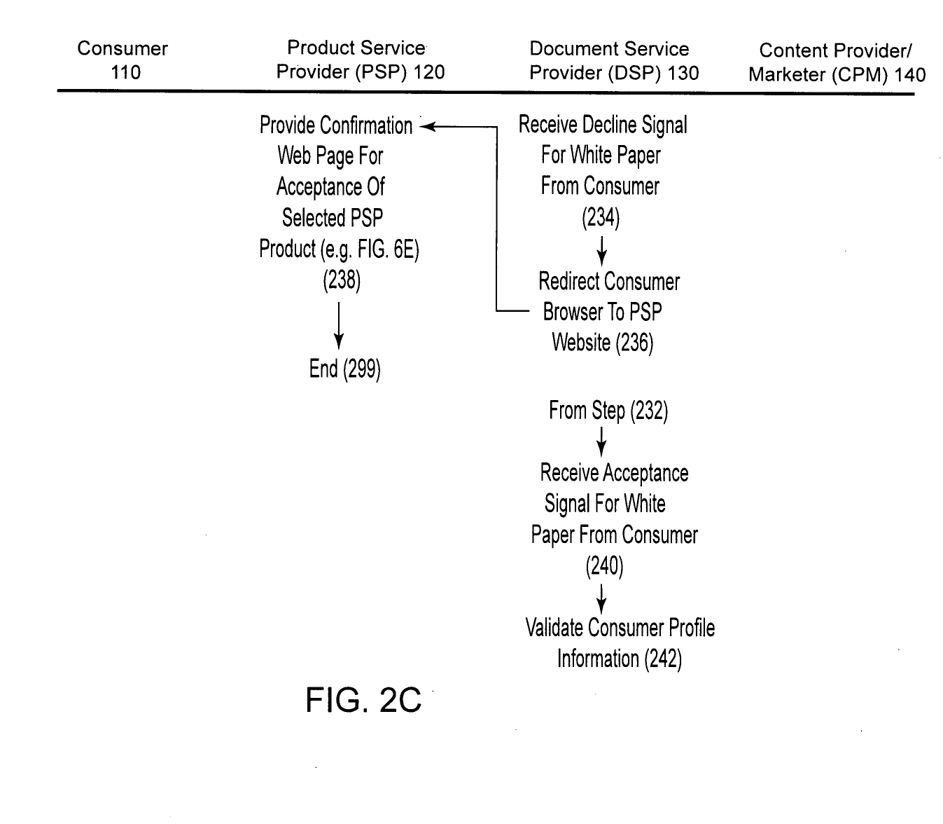

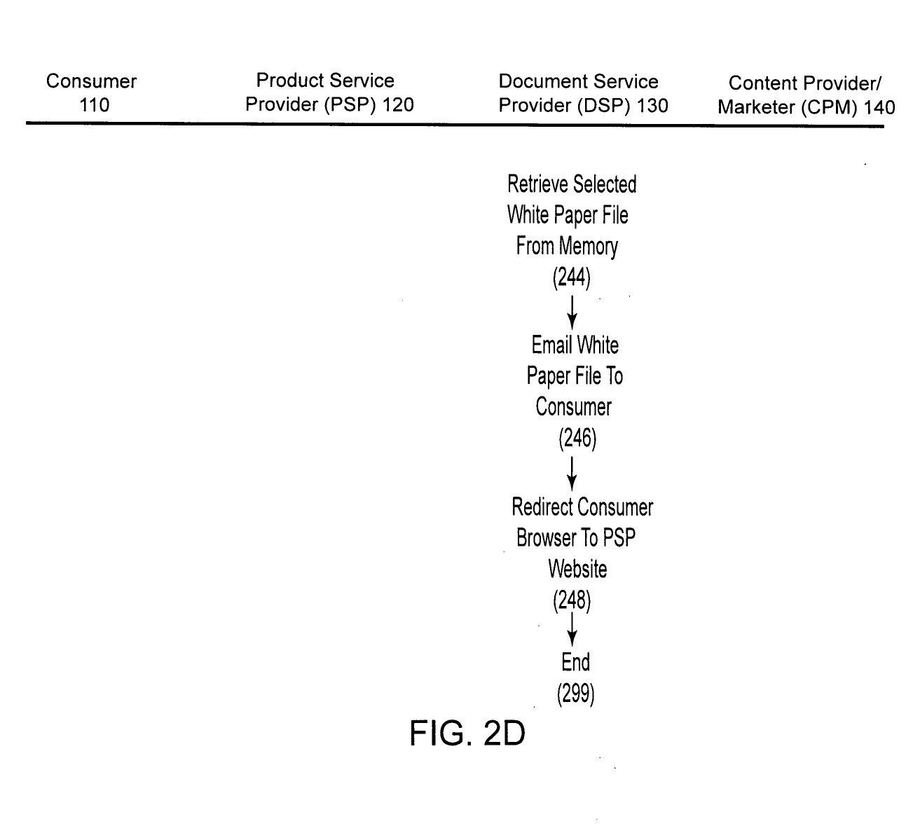

Finally, the consumers 110 purchase goods and/or services (i.e., products) using an end-user computer device having internet connectivity and web browsing capabilities, such as a desktop computer, laptop, cellular smart phone, or any other well-known computer device having capabilities to access and browse the Internet. As noted above, the consumer utilizes his/her computer device to access and browse products offered by the product service provider 120. In accordance with the present invention, when the consumer 110 selects a specific product, the DSP 130 generates and presents a new “interstitial” webpage to the consumer, which includes information regarding a selected white paper or other document that corresponds to the customer's profile, as well as the product being viewed and selected by the customer. In one embodiment, the customer is redirected to the website domain of the DSP 130 from the PSP's 120 website via URL redirection. Alternatively, the PSP 120 generates the interstitial webpage from data received from the DSP 130 over the internet. In either embodiment, if the customer accepts the offer for the white paper from the DSP 130, the PSP 120 displays a confirmation on the consumer's computer device 112 regarding the selection of the product, and the white paper is delivered electronically to the customer. Details of the operation of the document distribution system 100 of the present invention are discussed below with respect to FIGS. 2A-2D, 3A-3C, and FIGS. 6A-6E.

Referring to FIG. 4, a block diagram of a computer device 400 suitable for use by the DSP 130 of FIG. 1 is illustratively shown. The computer device 400 can be one or more servers that centrally manage white papers and other documents of the CPMs 140 at the website of the DSP 130, as well as execute programs to store customer profile information 440, store content provider information including author profile information 436, brief descriptions or abstracts 434 of the stored documents, and routines to select a particular document based on the product and/or customer profile information. Additional programs that assist in managing accounts, communications and other functions of the DSP 130 include authentication, authorization and accounting processes 420, 422 to ensure secure transactions and exchange of information, and a web page generator 424 to generate a promotional web page that includes a brief description or abstract of a selected white paper or other documents based on product and/or customer profile information, database fields for providing consumer profile information, and interfaces (e.g., clickable web browsing buttons) for accepting or declining the free white paper. The computer further stores product service provider profile information 438 and the author information 436 to manage accounting and other business relations and interactions between the DSP 130, the PSP 120 and the CPMs 140. The computer device 400 includes a multitasking, real-time software technology that can concurrently handle hundreds of thousands of queries and updates.

The computer device 400 can be any computer device such as a personal computer, minicomputer, workstation or mainframe, or a combination thereof. While the computer device 400 is shown for illustration purposes as a single computer unit, the computer system can comprise a group/farm of computers which can be scaled depending on the processing load and database size. Further, the group/farm of computers can include various computer devices or servers for performing designated operations, such as hosting websites, providing email services, data storage services, printing, authentication/authorization/accounting (AAA) services, among other services.

Specifically, the computer device 400 comprises at least one processor 402, as well as memory 410 for storing various control programs 412. The processor 402 may be any conventional processor, such as one or more “INTEL” processors. The memory 410 can comprise volatile memory (e.g., DRAM), non-volatile memory (e.g., disk drives) and/or a combination thereof. The processor 402 cooperates with support circuitry 406, such as power supplies, clock circuits, cache memory, among other conventional support circuitry, to assist in executing software routines (e.g., methods 200, 300) stored in the memory 410. The one or more processors 402, memory 410 and support circuitry 406 are all commonly connected to each other through one or more buses and/or communication mediums (e.g., cabling) 408.

The computer device 400 also comprises input/output (I/O) circuitry that forms an interface between various functional elements communicating with the computer device 400. For example, the computer device 400 can be connected to a communication link such as the Internet 102 or other computer network through an I/O interface 404, which receives information from and sends information over the communication link to various content providers 140, product service providers 120, and/or end-user customers 110.

The memory 410 includes program storage 412 and data storage 414. The program storage 412 stores an operating system (not shown) such as a “WINDOWS” operating system commonly available from “MICROSOFT” Corporation of Redmond, Wash. or any other well-known operating system, an authentication/authorization module 420, an accounting module 422, a document promotional web page generator module 424, among other application programs and data retrieval modules. In one embodiment, the web page generator 424 is an application program provided on a MICROSOFT.NET FRAMEWORK platform, although such software platform is not considered limiting. It is noted that the operating system and optionally various application programs (not shown) are stored in the memory 410 to run specific tasks and enable user interaction. The data storage 414 can be an internal or separate storage device, such as one or more disk drive arrays that can be accessed via the I/O interface 404 to read/write data. The data storage 414 includes one or more databases, such as a central database 430 that can store information pertaining to the white papers (documents) 432, document abstracts 434, document authors 436, product service provider profile information 438, customer profile information 440, among other information. The data storage 414 and/or central database 430 can be provided internally (as shown in FIG. 4) or externally (as shown in FIG. 1) to the computer device 400. In one embodiment, the administration modules 420 and 422, as well as the database 430 are provided on a LAMP platform, which is an open source program based on Linux OS, Apache HTTP server, MySQL and Perl/PHP, as is well-known in the art, although such software is not considered limiting.

Any of the software program modules in the program storage 412 and data from the data storage 414 are transferred to specific memory locations (e.g., RAM) as needed for execution by the processor 402. Although the white papers 432, abstracts 434, and author data 436 have been described as individual databases, a person of ordinary skill in the art will appreciate that these databases are not considered limiting. For example, one or more relational databases can be implemented to store and retrieve information as required.

As such, it is contemplated that some of the process steps discussed herein as software processes may be implemented within hardware, for example, as circuitry that cooperates with the processor 402 to perform various steps. It is further noted that various modules, such the authentication/authorization and accounting (AAA) module 420, 422 can be implemented on a separate computer device, such as an AAA server. The AAA server enables tracking the amount of network resources users are accessing and the types of services they are using. For example, system administrators might need to invoice departments or customers for connection time or resources used on the network (for example, total time connected). The AAA server can also be used to track suspicious connection attempts into the network. AAA authorization permits control of the network services available to each user and helps restrict access to internal networks. Further, the main authentication methods considered are username and password, S/Key, token card and server, Password Authentication Protocol (PAP), among other authentication techniques.

Referring to FIG. 5, a block diagram of a computer device 500 suitable for use by the product service provider 120 of FIG. 1 is illustratively shown. The computer device 500 can be one or more servers that centrally manage product information at the website of the product service provider, as well as execute programs to process product orders from the consumers 110, store customer profile information, provide authentication, authorization and accounting processes 420, 422 to ensure secure transactions, and store document service provider profile information 536 to manage accounting and other business relations and interactions between the PSP 120 and DSP 130.

The block diagram and description of the computer device 500 shown in FIG. 5 is essentially the same as described above with respect to the computer device 400 shown in FIG. 4, except that instead of storing a white paper promotional web page generator 424, a product web page generator 524 is stored in the program storage 412 to generate web pages that include information associated with the PSP 120. The information to generate the PSP's web pages is stored as product/service data 532 in memory 414. The product/service data 532 can include descriptions, features and/or specifications of products being offered, product reviews, warrantees, return policies, contact information, brick and mortar store locations (if any), legal notices, financial information, customer service policies, and other well-known product service provider information. Other data stored in the database 430 of the PSP computer device 120 can include DSP profile information 536, customer profile information 440 and optional DSP promotional web page (interstitial web page) data/metadata 534. The DSP profile information 536 can include information associated with the DSPs 130, such as name, address, contacts, URL, PSP/DSP fee schedules, and revenue tables, among other DSP related information.

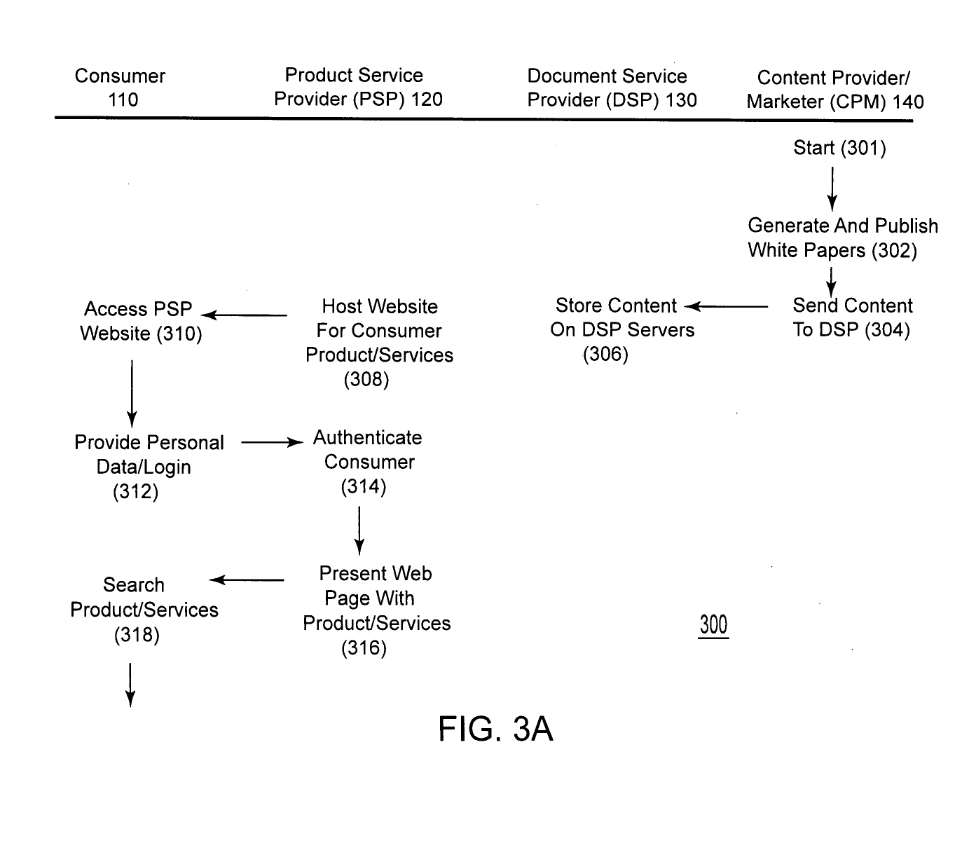

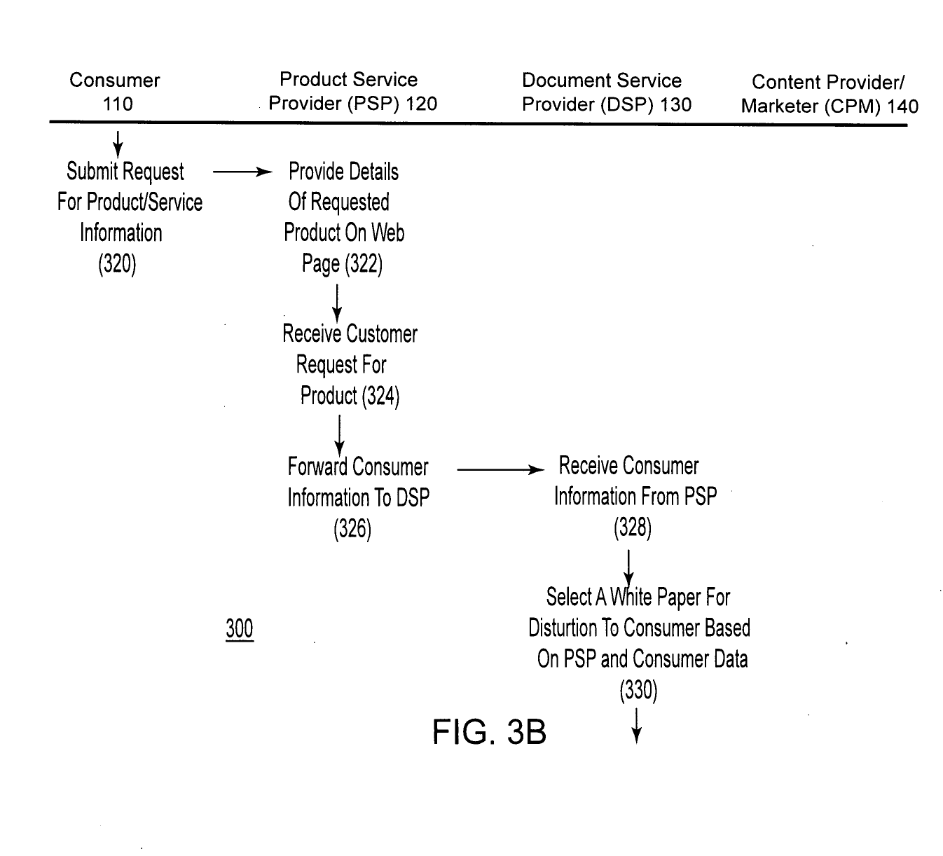

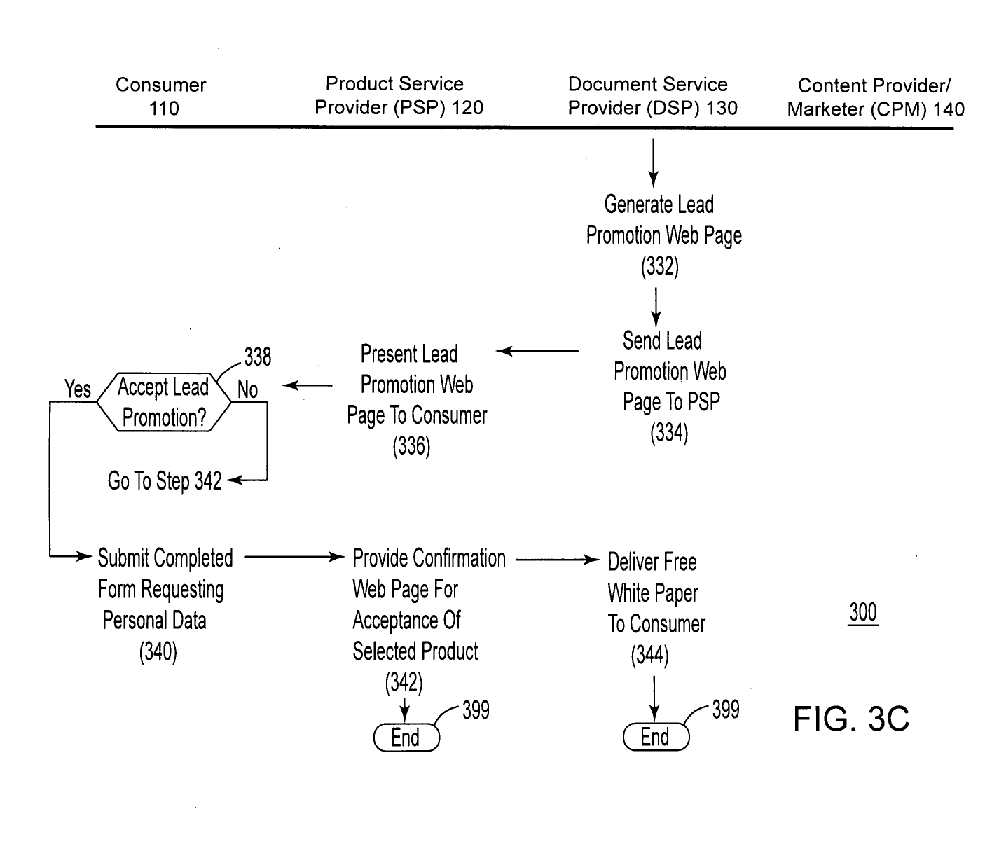

Preferably, the PSP 120 redirects the consumer 110 to the website of the DSP 130 to view an interstitial web page for promoting a white paper, as described below with respect to method 200 of FIGS. 2A-D and FIG. 6D. In an alternative embodiment described below with respect to method 300 of FIGS. 3A-3C and FIG. 6D, the PSP 120 sends a request message to the DSP 130 instructing it to send the interstitial web page information/metadata to the PSP 120, which then stores this information as DSP promotional web page data 534. The DSP promotional web page data 534 includes information that enables the PSP 120 to generate and temporarily host the interstitial web page. In particular, the web page generator 524 of the PSP 120 subsequently retrieves the data 534 to generate the interstitial web page illustratively shown in FIG. 6D for viewing and interaction by the consumer 110. It is noted that for the preferred embodiment implementing URL redirection, the DSP promotional web page data 534 is not required.

Referring now to FIGS. 2A-2D, a flow diagram of a method 200 for providing free promotional white papers or other documents to a consumer via the Internet in accordance with the present invention is illustratively shown. FIGS. 2A-2D include four columns, where the first column illustrates steps or actions taken by a consumer 110, the second column illustrates steps or actions taken by the product service provider (PSP) 120, the third column illustrates steps or actions taken by the document service provider (DSP) 130, and the fourth column illustrates steps or actions taken by a content provider/marketer (CPM) 140. The flow diagram of FIGS. 2A-2D should be viewed in conjunction with the system block diagram shown in FIG. 1 and the illustrative web pages shown in FIGS. 6A-6E. FIGS. 6A-6E depict examples of web pages from an employment firm that conducts business by posting job listings (i.e., the “product”) via the Internet, and a person of ordinary skill in the art will appreciate that these illustrative product web pages are not considered limiting.

The method 200 begins at step 201, and proceeds to step 202 where the individual CPMs 140 publish their white papers or other documents. The white papers can include discussions directed to studies, experiments, opinions, predictions and the like regarding subject matter in any field of interest, and which can be used by authors or other CPMs 140 as marketing tools to promote further discussion, investigation, opinions and business leads from others (i.e., potential customers) interested in the subject matter.

At step 204, the CPMs 140 send an electronic copy of the white paper or other document to the document service provider (DSP) 130. At step 206, the DSP 130 stores each white paper in a repository 414. The DSP repository is operable with one or more computer devices such as described with respect to FIG. 4. In one embodiment, the DSP 130 includes a database 430 with fields that identify classes and subclasses associated with the subject matter of the white papers. A brief description or abstract is also stored in the database 430 for each white paper. In this manner, the DSP 130 can expediently perform searches to identify white papers associated with a specific topic, and the searches can be refined with various filtering techniques, such as with Boolean operators, word searches, among other well-known searching techniques.

At step 208, the product service provider (PSP) 120 hosts a website for consumer products (i.e., goods and/or services) offered by the PSP 120 or affiliate thereof. The PSP website is hosted on one or more computer devices 500 such as described with respect to FIG. 5. The PSP website includes one or more web pages that provide graphical and/or textual information relating to the PSP 120 and the goods/services offered to consumers 110. The web pages are accessible in a well-known manner by any consumer having internet and web browsing capabilities, such as with a laptop computer having an INTERNET EXPLORER® web browser from MICROSOFT or any other computer device having web browsing capabilities.

At step 210, a consumer can accesses the PSP's website using a computer device 112 having well-known internet browsing capabilities. At step 212, the consumer accesses and browses one or more web pages hosted by the PSP 120 to search for one or more products (i.e., goods and/or services) offered by the PSP 120. The web page generator 524 of computer device 500 generates for display on the consumer's computer device 112, an illustrative first web page which illustratively includes a list of job positions from different companies, as illustratively shown in FIG. 6A.

Referring to FIG. 6A, the illustrative web page 610 is hosted by an internet based employment firm (DICE.COM). One product of this illustrative product service provider 120 is to provide a service for matching employers and potential employees together to fulfill an employment position, illustratively, in the field of technology. An employer posts the employment position on the website of the PSP 120 such that the consumer can then search the job listings using various searching techniques including entering alphanumeric characters into search fields, scrolling among other browsing and searching techniques. Each job listing can be hyperlinked to another web page so that the consumer can select a specific product, i.e., job listing from the web page of FIG. 6A and a new web page will appear on the consumer's computer device 112. For example, the web page generator 524 of the PSP (DICE.COM) 120 illustratively presents a second web page 620 as shown in FIG. 6B.

Further, at step 212, the consumer 110 can submit a request from the web page of FIG. 6A for detailed product information by clicking on, for example, a specific job listing such as the “ERP Business Analyst (SAP) Functional Consultant” position identified by reference number 612 in FIG. 6A. As a result, a second web page 620 is displayed on the consumer's computer device 112, as shown in FIG. 6B. The second web page 620 includes a detailed description of the product (e.g., the selected job position) 622. The consumer can continue to browse through the web site of the PSP to find a desired product shown on a web page of the PSP in a conventional manner. Although two web pages (FIGS. 6A and 6B) are illustratively shown, the number of web pages presented by the PSP 120 is not considered limiting.

At step 214, the consumer can click on a button or other well-known browser interface 624 on the illustrative web page 620 of FIG. 2B to select, request or otherwise order the product. At step 216, the web page generator 524 of the PSP 120 optionally presents a third web page (e.g., job application landing page) 630 as illustratively shown in FIG. 6C. Referring to FIG. 6C, an illustrative “Job Application Landing Page” 330 is displayed on the consumer's computer device 112. The optional third web page 630 is hosted by the PSP 120 and includes various fields for providing consumer profile information 632, such as customer name, email contact information, and/or other personal identifiable information (PII). At step 218, the consumer can submit (login/register) the consumer profile information to the PSP 120 by clicking on the login/registration button 634. The method 200 then proceeds to step 220.

At step 220, the PSP 120 receives the submitted consumer profile information, and at step 222, the consumer is automatically redirected (i.e., forwarded) to a website hosted by the DSP 130. That is, the PSP 120 will redirect or forward the consumer (e.g., job seeker) to an interstitial web page being hosted at the website of the DSP 130 in a well-known manner. An example of an interstitial web page 640 generated by the DSP 130 for display on the consumer's computer device 112 is illustratively shown in FIG. 6D

At step 224, the DSP 130 receives the customer profile and product information which can be used to generate the interstitial web page 640. During the process of URL redirection to the DSP 130, the consumer's PII is transferred to the DSP's Lead Generation Interstitial 640 via the query string of the URL. At step 226, as the Lead Generation Interstitial 640 is being loaded by the consumer's (e.g., Job Seeker's) browser on the computer device 112, the Interstitial 640 is programmed to pre-populate its demographic form fields (e.g., first name, last name, e-mail address, mailing address, city, state, zip, phone number and company name) with the PII included in the query string of the URL. If one or more fields of PII are not passed to the Interstitial 640, it will leave the respective form fields blank.

During or immediately following the pre-population of the PII fields, at step 228, the Interstitial 640 retrieves an asset (e.g., white paper) from the DSPs queue to serve to the consumer (e.g., Job Seeker) 110. The search criteria for selecting an appropriate white paper can include, but is not limited to any one or combination of criteria including the customer profile information, the product selected by the customer, and related technologies or subject matter. Additionally, selection of a particular white paper can be based on financial incentives of the content providers, such as fee rates and/or quotas for white paper distributed by the DSP 130. Other criteria for selecting a particular white paper for a customer can include inventory quotas, alignment with a PSP brand or product, among other criteria. The drivers for performing the retrieval process (force and default flags and sequence order) of the assets (e.g., white papers) are fully controlled by DSP 130 through a protected, administrative web site. Assets may be forced to the top of the heap always or sequenced by business priority. In one embodiment, assets are bypassed in the queue if they do not have positive inventory. Once an asset is selected, the webpage generator 424 will dynamically retrieve the meta-data (e.g., logo, title, description, inventory, survey and other information) from the DSP's asset database to generate the interstitial web page 640. The asset meta-data is fully controlled by DSP 130 through a protected, administrative Web site. The interstitial web page 640 includes a brief description or abstract 642 of the white paper or other document selected for the consumer 110 in step 228. The web page generator 424 retrieves the abstract information from storage 434 in the central database 430 and inserts the content into the web page 640.

Following retrieval of the selected asset (e.g., white paper), the web page generator 424 dynamically builds the asset's survey form or section 646 of the interstitial web page 640, which the consumer must complete to receive the asset (e.g., white paper, webinar, or other literature) selected from the database 432. The DSP 130 will provide the survey information from the survey section 646 to the CPM (e.g., IBM or other vender) 140 associated with the asset that was selected for the consumer 110. The CPM 140 can use the survey information 646 to determine if the consumer 110 is appropriate and/or likely to be open to receive further solicitations for products (e.g., services) from the CPM 140.

The fields of the survey 646 can include questions, answers, and/or presentation, etc., and is fully configured by the DSP 130 through its protected administrative website. For example, the survey 646 can include questions such as “what is your job title”, company size, company location, and the like, as well as a choice of answers, such as “Director”, “Officer”, “Manager” and/or “Engineer”, among other answers the consumer can choose. The survey 646 can contain any number of fields in varied formats such as, e.g., drop-down lists, radio buttons, checkboxes, open text fields, and the like. The survey 646 can also include grading rules which are used by the CPM 140 to determine which “consumer leads” the CPM will 140 accept. For example, the grading rules may dictate that only persons having job titles of “vice president” or “directors” with particular job functions related to engineering for companies having greater than 100 employees and located in a particular geographical area (e.g., Northeast USA) will be selected for further solicitation of services by the CPM 140.

At step 230, once the Interstitial page 640 is generated and displayed on the consumer's computer device 112, the consumer (e.g., Job Seeker) 110 can complete the survey form and either accept or decline the offer by clicking on one of the corresponding buttons 644. From the perspective of the consumer 110, the interstitial web page 640 is presented seamlessly after submitting the consumer profile information 632 from the third web page of FIG. 6C. If at step 232, the consumer declines the offer for the white paper (i.e., promotional lead), the method proceeds to step 234.

Referring to FIG. 2C, at step 234 the website server 400 of the DSP 130 receives the decline signal from the consumer's computer device 112. At step 236, the consumer is redirected back to the PSP's website again via URL redirection. In particular, the URL of the PSP 120 is included the query string sent by the PSP 120 to the DSP 130 during step 224. The method 200 then proceeds to step 238.

At step 238, the PSP 120 web page generator 524 of the PSP 120 generates a confirmation webpage for display on the consumer's browser 112 to notify the consumer that the product ordered on the PSP's website has been received and/or accepted. Referring to FIG. 6E for example, an illustrative job application confirmation web page 650 is illustratively shown. The illustrative web page 650 includes a text message 652 indicating that the consumer's job application has been sent (e.g., emailed) to the employer of the selected job position. The method 200 proceeds to step 299, where the method ends and the consumer can browse for products at the same or other PSP 140 in a well-known manner.

Referring back to FIG. 2B, if at step 232 the consumer accepts the offer by clicking the “Submit” button, which sends the survey information 646 to the DSP 130. The method 200 then proceeds to step 240. Referring now to FIG. 2C, at step 240 the website hosted by the computer 400 of the DSP 130 receives the acceptance signal from the consumer, and at step 242, the DSP website validates the form field data by ensuring that the survey 646 does not include false information e.g., faux names such as “Mickey Mouse” and the like, or other false or inconsistent information, such as mismatched zip codes and addresses, phone numbers, and the like. Once the submitted consumer information is validated, the DSP 130 and stores the order request for the asset (e.g., white paper), as well as the consumer's PII/profile information, order IP address from the source (i.e., consumer computer device), among other consumer information in the DSP's fulfillment database 442.

At step 246, the free promotional white paper (or other document) is sent to the consumer 110. In one embodiment, the DSP 130 directly emails the white paper to the consumer, for example, in PDF format. Alternatively, the white paper can be presented as a link on the confirmation page 650 (FIG. 6E) such that the consumer 110 can download the white paper as a file (e.g., PDF, hypertext, among other formats). Once the consumer 110 receives the white paper, the method 200 proceeds to step 299 where the method ends and the consumer can continue browsing the PSP website for other products or log off.

Although the present invention has been described and shown using five web pages to illustrate the consumer interaction with the PSP 120, a person of ordinary skill in the art will appreciate that the number of web pages displayed to the consumer 110 is dependent on the architecture of the PSP's website and is not considered limiting.

Referring now to FIGS. 3A-3C, a flow diagram of a method 300 for providing free promotional white papers or other documents to a consumer via the Internet in accordance with the present invention is illustratively shown. FIGS. 3A-3C includes four columns, where the first column illustrates steps or actions taken by a consumer 110, the second column illustrates steps or actions taken by the product service provider (PSP) 120, the third column illustrates steps or actions taken by the document service provider (DSP) 130, and the fourth column illustrates steps or actions taken by a content provider/marketer (CPM) 140. The flow diagram of FIGS. 3A-3C should be viewed in conjunction with the system block diagram shown in FIG. 1 and the illustrative web pages shown in FIGS. 6A-6E. As noted above, FIGS. 6A-6E depict examples of web pages from an employment firm that conducts business by posting job listings (i.e., the “product”) via the Internet, and such product web pages are not considered limiting.

The method 300 begins at step 201, and proceeds to step 302 where the individual CPMs 140 publish their white papers or other documents. The white papers can include discussions directed to studies, experiments, opinions, predictions and the like regarding subject matter in any field of interest, and which can be used by authors or other CPMs 140 as marketing tools to promote further discussion, investigation, opinions and business leads from others (i.e., potential customers) interested in the subject matter.

At step 304, the CPMs 140 send an electronic copy of the white paper or other document to the document service provider (DSP) 130. At step 306, the DSP 130 stores each white paper in a repository 414. The DSP repository is operable with one or more computer devices such as described with respect to FIG. 4. In one embodiment, the DSP 130 includes a database 430 with fields that identify classes and subclasses associated with the subject matter of the white papers. A brief description or abstract is also stored in the database 430 for each white paper. In this manner, the DSP 130 can expediently perform searches to identify white papers associated with a specific topic, and the searches can be refined with various filtering techniques, such as with Boolean operators, word searches, among other well-known searching techniques.

At step 308, the product service provider (PSP) 120 hosts a website for consumer products (i.e., goods and/or services) offered by the PSP 120 or affiliate thereof. The PSP website is hosted on one or more computer devices 500 such as described with respect to FIG. 5. The PSP website includes one or more web pages that provide graphical and/or textual information relating to the PSP 120 and the goods/services offered to consumers 110. The web pages are accessible in a well-known manner by any consumer having internet and web browsing capabilities, such as with a laptop computer having an INTERNET EXPLORER® web browser from MICROSOFT or any other computer device having web browsing capabilities.

Referring to FIG. 6A, a first web page 610 posted by an internet based employment firm (DICE.COM) is illustratively shown. One product of this illustrative product service provider is to provide a service for matching employers and potential employees together to fulfill an employment position, illustratively, in the field of technology. An employer posts the employment position on the website of the PSP 120 such that at step 310, a consumer can first review general information and then review more detailed information by browsing different web pages of the PSP 120. More specifically, the web page generator 524 of computer device 500 generates the illustrative first web page which illustratively includes a list of job positions from different companies as shown in FIG. 6A. In order to view specific job positions, at step 312 (FIG. 3A), the consumer may be asked to register and provide the PSP 120 with consumer profile information, such as his/her name, address, education degrees, contact information, occupation, and the like. Optionally, at step 314, the PSP 120 authenticates the consumer. Alternately, the consumer profile information and/or login procedure/authentication steps can be performed at a later step, for example, as described below with respect to steps 320 and 322 and FIG. 6C. Where the consumer 110 is authenticated, at step 316, a home web page is presented to the consumer on the consumer's computer device 112. In either embodiment (optional login/authentication or no login/authentication required at this time), at step 318 the consumer can then search the job listings using various searching techniques such as search fields or scrolling bars as shown in the illustrative web page of FIG. 6A. Each job listing can be hyperlinked to another web page so that the consumer can select a specific product, i.e., job listing from the web page of FIG. 6A and a new web page (e.g., the web page shown in FIG. 6B) will appear on the consumer's computer device 112.

Referring to FIG. 3B, at step 320, the consumer 110 can submit a request for detailed product information by clicking on, for example, a specific job listing such as the “ERP Business Analyst (SAP) Functional Consultant” position identified by reference number 612 in FIG. 6A. At step 322, the web page generator 524 of the PSP (DICE.COM) 120 presents a second web page 620 as shown in FIG. 6B. The second web page 620 includes a detailed description of the product (e.g., the selected job position) 622. At step 324, the consumer can request or otherwise order the product by clicking on a button or other well-known browser interface 624 on the web page 620 of FIG. 6B. In one embodiment, the web page generator 524 of the PSP 120 optionally presents a third web page (e.g., job application landing page) 630 as illustratively shown in FIG. 6C. The optional third web page 630 includes fields for providing consumer profile information 632, such as customer name, email contact information, and/or other personal identifiable information (PII). This consumer profile information can be used for authentication purposes at product service provider websites, which did not initially require the consumer to login as described above with respect to steps 312 and 314 of FIG. 3A.

At step 326, once the consumer submits the personal profile information, the PSP's 120 computer device 500 is programmed to insert a “Lead Generation Interstitial” web page 640 (e.g., FIG. 6D) from the DSP 130 into the browser of the consumer's computer device 112. The PSP 120 sends an electronic message via the Internet 102 to the DSP 130 containing customer profile information and the product selected by the customer. In yet another embodiment, the customer can directly send an electronic message via the Internet 102 to the DSP 130 containing customer profile information and the product selected by the customer. At step 328, the DSP 130 receives the customer profile and product information, and the method 300 then proceeds to step 330.

At step 330, the DSP 130 searches for and selects a white paper or other document that is personalized to the customer. The search criteria for selecting an appropriate white paper can include, but is not limited to any one or combination of criteria including the customer profile information, the product selected by the customer, and related technologies or subject matter. Additionally, selection of a particular white paper can be based on financial incentives by the content providers, such as fee rates and/or quotas for white paper distributed by the DSP. Other criteria for selecting a particular white paper for a customer can include inventory quotas, alignment with a PSP brand or product, among other criteria.

Referring to FIG. 3C, at step 332, the promotional web page generator 424 of computer device 400 generates a lead promotion web page 640, as illustratively shown in FIG. 6D. The lead promotion web page 640 provides a brief description or abstract 642 of the white paper or other document selected for the consumer 110 in step 330. The web page generator 424 retrieves the abstract information from storage 434 in the central database 430 and inserts the content into the web page 640. The web page generator 424 also inserts the received consumer profile information into the appropriate fields of the survey section 646. The web page 640 also includes one or more interface buttons 644 to accept or decline receiving the white paper. At step 334, the DSP 130 sends the lead promotion web page 640 to the PSP 120, and at step 336, the PSP 120 presents the lead promotion web page 640 on its website for viewing by the consumer 110. From the perspective of the consumer 110, the promotion web page 640 is presented seamlessly after submitting the consumer profile information 632 in the third web page of FIG. 6C.

At step 338, if the consumer declines the offer for the promotional white paper, then the method 300 proceeds to step 342, where the PSP 120 displays a fifth web page 650 which shows confirmation that the product ordered by the consumer has been accepted by the PSP 120. With respect to the present example, the product web page generator 524 generates the web page 650, which includes text 652 to confirm that the application for the job selected by the consumer 110 was sent. Once the confirmation page 650 is presented to the consumer 110, the method 300 proceeds to step 399 where the method ends and the consumer can continue browsing the PSP website for other products or log off.

Alternatively, if at 338 the consumer decides to accept the offer for the promotional white paper, then the method 300 proceeds to step 340. At step 340, the consumer 110 completes the additional consumer profile information of the survey section 646 shown on the web page 640 of FIG. 6D. The additional consumer profile information is used by the CPM 140 for soliciting business, as opposed to the consumer profile information being used by the PSP 120 for there own business purposes. The consumer submits the completed form of the promotional web page 640, and the method proceeds to step 342. At step 342, the PSP 120 displays the fifth web page 650 (FIG. 6E) as described above, which provides confirmation that the product ordered by the consumer has been accepted. Once the web page generator 524 generates the web page 650 which includes text 652 to confirm that the application for the job selected by the consumer 110 was sent, the method proceeds to step 344.

Although the present invention has been described and shown using five web pages to illustrate the consumer interaction with the PSP 120, a person of ordinary skill in the art will appreciate that the number of web pages displayed to the consumer 110 is dependent on the architecture of the PSP's website, and is not considered limiting.

At step 344, the free promotional white paper (or other document) is sent to the consumer 110. In one embodiment, the DSP 130 directly emails the white paper to the consumer. Alternatively, the white paper can be presented as a link on the confirmation page 650 (FIG. 6E) such that the consumer 110 can download the white paper as a file (e.g., PDF, hypertext, among other formats). Once the consumer 110 receives the white paper, the method 300 proceeds to step 399 where the method ends and the consumer can continue browsing the same or other PSP website for products or log off.

The present invention advantageously enables CPMs 140 such as authors of published white papers or other documents to expand publication to consumers who would not otherwise have an opportunity to receive the white papers. Broadening the distribution of white papers to the general public is accomplished by partnering with a document service provider 130 or publisher that has contacts or business relations with product service providers 120. When a consumer accesses a products service provider's website via the Internet 102, the consumer is given an opportunity to receive a preselected white paper that can be personalized for the consumer based on various criteria including the products being viewed by the consumer and consumer profile information.

From the perspective of the consumer 110, the consumer 110 benefits because they have an opportunity to receive a free white paper or other document that is related to the topic of interest that they are searching for on the Internet. Accordingly, the free white paper provides additional knowledge and/or opinions with regard to the product being searched. Further, the content of the white papers are current and relevant to the consumer's interests, thereby assisting the consumer in making an informed purchasing decision.

From the perspective of the CPM 140, the content provider 140 benefits because the white paper has greater public distribution than previously available to the CPM. Further, the CPM 140 receives better qualified business leads, since the white papers are distributed to targeted consumers. The increased distribution of the white paper enables the author to promote or otherwise market the content provider's name and skills to individuals and entities that may find such talents useful. Accordingly, the CPM 140 can see a higher conversion of sales for services based on increased consumer interest.

With regard to the product service provider 120, such entity can help enhance sales or promotion of their own products by offering the additional service of providing free literature on subject matter related to their products. For example, the white papers that are directly relevant to the products the PSP sells will enhance sales of the PSP's products. Additionally, the PSP 120 can participate in revenue sharing or other consideration for contributing to the distribution of the free literature. For example, the CPMs 140 can agree to pay a fee for sending a white paper to an end-user consumer.

From the perspective of the document service provider 130, the DSP 130 benefits by receiving a fee or other consideration for promoting the white papers from the CPMs 140. For example, the distribution of the white papers is helpful to create a robust partnership network between the CPMs, DSP, and PSPs, which builds a better business channel for distributing products.

It will be apparent to those of ordinary skill in the art that various modifications and variations can be made to the present invention without departing from the spirit and scope of the invention. Thus, it is intended that the present invention cover the modifications and variations of this invention that come within the scope of the appended claims and their equivalents.

What is claimed is:

1. A method for promoting business leads for authors of literature to a consumer by a document service provider that stores and manages the literature via the Internet, the consumer having a computer device for accessing product information via the Internet at a website hosted by a product service provider, the method comprising the steps of:
receiving, via the Internet, profile information of the consumer from the product service provider while the consumer is browsing product information or utilizing services from the website of the product service provider;
identifying, at the document service provider, at least one corresponding document associated with a product being viewed at the website of the product service provider by the consumer;
presenting, on the consumer computer device, a lead promotional web page graphical user interface (GUI) that includes an offer by the document service provider to the consumer for the corresponding document; and
delivering the corresponding document to the consumer in response to receiving an acceptance of the offer.

2. The method of claim 1, wherein the receiving step further comprises storing the consumer profile information in a database.

3. The method of claim 1, wherein the literature includes a plurality of white papers associated with various commercial and governmental entities.

4. The method of claim 1, wherein the identifying step includes the step of filtering documents based on the product selected by the customer on the website of the product service provider and the customer profile information.

5. The method of claim 4, wherein the filtering step includes identifying at least one category of interest from the fields of technology, arts, demographics, health, geography, politics, history, business, religion and social services.

6. The method of claim 4, wherein the filtering step includes identifying document lead criteria including at least one of quotas and document payment rates.

7. The method of claim 1, wherein the presenting step further includes generating the lead promotional web page with prompts for completing a plurality of fields associated with additional customer profile information.

8. The method of claim 1, wherein the presenting step further includes generating the lead promotional web page with prompts for accepting and declining the offer for the corresponding document.

9. The method of claim 1, wherein the presenting step comprises the step of automatically displaying the promotional web page GUI on the computer device of the consumer from a website hosted by the document service provider in response to URL redirection from the product service provider.

10. The method of claim 9, wherein the presenting step further comprises the step of providing URL redirection at the document service provider to enable the consumer computer device to access a confirmation web page from the website hosted by the product service provider.

11. The method of claim 1, wherein the presenting step comprises the steps of:
receiving a request over the internet from the product service provider for the promotional web page GUI; and
sending data for generating the promotional web page GUI over the internet from the document service provider to the product service provider, wherein the promotional web page GUI is hosted by the product service provider for display on the computer device of the consumer.

12. The method of claim 1 further comprising:
aggregating a number of occurrences that the document was delivered to consumers; and
delivering an invoice for payment to the author based on the aggregated number.

13. The method of claim 1, wherein the delivery step includes sending the document to the customer via email and/or by providing a link on a webpage for downloading the document.

14. A system for promoting business leads for authors of literature to a consumer by a document service provider that stores and manages the literature via the Internet, the consumer having a computer device for accessing product information via the Internet at a website of a product service provider, and the system including at least one computer device having memory for storing a promotional web page module and a processor for executing instruction therefrom, said computer device operable to:
receive, via the Internet, profile information associated with the consumer from the product service provider while the consumer is reviewing product information from the website of the product service provider;
identify, at the document service provider, at least one corresponding document associated with a product being viewed at the website of the product service provider by the consumer;
present, on the consumer computer device, a lead promotional web page graphical user interface (GUI) that includes an offer by the document service provider to the consumer for the corresponding document; and
deliver the corresponding document to the consumer in response to receiving an acceptance of the offer.

15. The system of claim 14, wherein the at least one computer device is further operable to store said consumer profile information.

16. The system of claim 15, wherein said literature includes a plurality of white papers.

17. The system of claim 16, wherein the at least one computer device is further operable to filter the plurality of white papers for delivery to the consumer based on at least one category of interest from the fields of technology, arts, demographics, health, geography, politics, history, business, religion, social services, and consumer profile information.

18. The system of claim 14, wherein the promotional web page module includes programmed instructions to generate the lead promotional web page GUI, said lead promotional web page GUI including a description of a document selected from the literature specifically for delivery to the customer and means for accepting or declining the offer.

19. The system of claim 18, wherein the at least one computer device is further operable to receive over the interne a request to accept or decline the offer for the document from the consumer computer device.

20. The system of claim 14, wherein the lead promotional web page GUI is generated in response to the consumer computer device being redirected from the website of the product service provider to a website hosted by the document service provider.

21. The system of claim 20, wherein the computer device is further operable to provide URL redirection to enable the consumer computer device to access a confirmation web page from the website hosted by the product service provider.

22. A system for promoting business leads for authors of literature to a consumer by a document service provider that stores and manages the literature via the Internet, the consumer having a computer device for accessing product information via the Internet at a website of a product service provider, the system comprising:
at least one first computer device having memory for storing a promotional web page module and a processor for executing instruction therefrom, said first computer device operable to:
receive, via the Internet, profile information of the consumer from the product service provider while the consumer is reviewing product information from the website of the product service provider;
identify, at the document service provider, at least one corresponding document associated with a product being viewed at the website of the product service provider by the consumer;
present, on the consumer computer device, a lead promotional web page graphical user interface (GUI) that includes an offer by the document service provider to the consumer for the corresponding document; and
deliver the corresponding document to the consumer in response to receiving an acceptance of the offer;
at least one second computer device having memory for storing a product web page module and a processor for executing instruction therefrom, said second computer device operable to present, on the consumer computer device, one or more web pages including descriptions of good and/or services available for selection by the consumer via the Internet; and
at least one database including stored literature and communicably coupled to the document service provider.

23. The system of claim 22, wherein the promotional web page module includes programmed instructions to generate the lead promotional web page GUI, said lead promotional web page GUI including a description of a document selected from the literature for delivery to the customer, and means for accepting or declining the offer.

24. The system of claim 22, wherein the at least one second computer device is operable to redirect the consumer computer device to the at least on first computer device to view the lead promotional web page GUI in response to the consumer computer device sending a request for selected goods and/or services.

25. The system of claim 22, wherein the at least one second computer device is operable to send a request to the at least on first computer device to receive data for generating the lead promotional web page GUI in response to the consumer computer device sending a request for selected goods and/or services, and said at least one first computer device sends the data to the at least one second computer device which generates the lead promotional web page GUI for display on the consumer computer device.
